(19) United States
(12) Patent Application Publication
(10) Pub. No.: US 2013/0124152 A1
(43) Pub. Date: May 16, 2013

(54) APPARATUS AND METHOD FOR EXPRESSING CHEMICAL COMPOUND WITH LINE NOTATION FOR DISTINGUISHING ISOMERS, AND APPARATUS AND METHOD FOR SEARCHING FOR COMPOUND USING THE SAME

(71) Applicant: Kwang-Hwi CHO, Yongin-si (KR)

(72) Inventor: Kwang-Hwi CHO, Yongin-si (KR)

(73) Assignee: Foundation Soongsil University-Industry Cooperation, Seoul (KR)

(21) Appl. No.: 13/612,041

(22) Filed: Sep. 12, 2012

(30) Foreign Application Priority Data
Nov. 14, 2011 (KR) 10-2011-0118546

(51) Int. Cl. G06F 17/50

(52) U.S. Cl. 703/1

(57) ABSTRACT

Expressing a line notation for distinguishing isomers for searching a compound includes, inter alia, input unit, an atom analysis unit, an atom alignment unit, and a string production unit. An input unit receives an input file regarding three-dimensional coordinate information of each target compound atom. An atom analysis unit analyzes bond relations between the atoms based on the three-dimensional coordinate information. Bond relations corresponding to isomers are defined separately. An atom alignment unit sequentially aligns the atoms based on the preset bond relations priority, producing an array of atoms. A string production unit produces a one-dimensional string corresponding to the target compound using predefined layers to express bond relations between the atoms and the array of atoms. Stereoisomers of compounds having peptide bonds, consecutive double bonds or metals can be more distinctly distinguished, and the double bonds of the compound can be expressed using four kinds of notation.

### CROSS-REFERENCE TO RELATED APPLICATION

This application claims priority to and the benefit of Korean Patent Application No. 2011-0118546, filed on Nov. 14, 2011, the disclosure of which is incorporated herein by reference in its entirety.

### BACKGROUND OF THE INVENTION

1. Field of the Invention

The present invention relates to an apparatus and method for expressing a chemical compound with line notation for distinguishing isomers and an apparatus and method for searching for a compound using the same, and, more particularly, to an apparatus and method for expressing the three-dimensional structure of a compound as a one-dimensional string and to an apparatus and method for searching for a compound in a database having one-dimensional line notation stored therein.

2. Description of the Related Art

Techniques for analyzing and systematically arranging compounds to store them in databases are gaining attention as the main concern in chemistry and related fields. In such databases, however, different compounds may be stored under the same name or the same compound may be stored under different names or IDs. Thus the efficiency of the database may decrease undesirably.

The best method of certifying the identity of a compound from the database is that the three-dimensional structure of the compound is converted into a one-dimensional string and then comparing these outputs. Methods of imparting unique strings to respective compounds used mainly to date include SMILES (Simplified Molecular Input Line Entry Specification) and InChI (International Chemical Identifier).

SMILES is a line notation method which explains the three-dimensional structure of a compound. This method was first devised in the 1980s and then modified through a plurality of different algorithms and has been widely utilized. However, SMILES is problematic because a molecule with different atom order may produce different SMILES code, and it is difficult to apply it to compounds having complicated structures. And, SMILES is a standardization of how to express the structural characters so a compound may have different SMILES code with different SMILES code generation algorithms.

InChI which is a string expression method developed recently may solve the problems of SMILES because it takes into consideration the direction and order of the array of atoms contained in a given input file. However, InChI expresses all of the chemical bond modes as a single form, undesirably resulting in low readability. Also it is difficult to judge the number and size of rings in the chemical structure expressed using InChI.

In conclusion, SMILES and InChI do have limitations in expressing structures of compounds having peptide bonds, consecutive double bonds, or metals. Furthermore, the case when the one-dimensional string of the compound is inversed into the three-dimensional structure thereof undesirably decreases accuracy.

U.S. Pat. No. 7,899,827 discloses System And Method For The Indexing Of Organic Chemical Structures Mined From Text Documents in order to process documents including the names of compounds. However, this patent does not propose methods of expressing compounds having peptide bonds, consecutive double bonds, or metals.

### SUMMARY OF THE INVENTION

Therefore, an object of the present invention is to provide an apparatus and method for expressing a compound with a line notation for distinguishing isomers by additionally including the classification of compounds in consideration of their structural properties to InChI which converts the three-dimensional structures of compounds into one-dimensional strings (line notation), and an apparatus and method for searching for the compound using the same.

Another object of the present invention is to provide a computer-readable storage medium which stores a program that may execute, on a computer, the method of expressing a line notation for distinguishing isomers by additionally including the classification of compounds in consideration of their structural properties to InChI which converts the three-dimensional structures of compounds into one-dimensional strings, and the method of searching for the compound using the same.

In order to accomplish the above objects, the present invention provides an apparatus for expressing a line notation for distinguishing isomers, comprising an input unit configured to receive an input file in which three-dimensional coordinate information of each of a plurality of atoms of a target compound which will be expressed as a one-dimensional string is recorded in a preset format; an atom analysis unit configured to analyze bond relations between the plurality of atoms based on the three-dimensional coordinate information, in which bond relations corresponding to isomers are defined separately; an atom alignment unit configured to sequentially align the plurality of atoms based on priority of the bond relations which are preset, thus producing an array of atoms; and a string production unit configured to produce a one-dimensional string corresponding to the target compound by means of a plurality of layers which are predefined so as to express bond relations between the plurality of atoms and the array of atoms.

In addition, the present invention provides a method of expressing a line notation for distinguishing isomers, comprising receiving an input file in which three-dimensional coordinate information of each of a plurality of atoms of a target compound which will be expressed as a one-dimensional string is recorded in a preset format; analyzing bond relations between the plurality of atoms based on the three-dimensional coordinate information, in which bond relations corresponding to isomers are defined separately; sequentially aligning the plurality of atoms based on priority of the bond relations which are preset, thus producing an array of atoms; and producing a one-dimensional string corresponding to the target compound by means of a plurality of layers which are predefined so as to express bond relations between the plurality of atoms and the array of atoms.

In addition, the present invention provides an apparatus for searching for a compound using the apparatus for expressing a line notation for distinguishing isomers of the invention, comprising a coordinate information input unit configured to receive from a user three-dimensional coordinate information of each of a plurality of atoms of a target compound which will be searched for; a string conversion unit configured to produce a one-dimensional string corresponding to the target compound based on the three-dimensional coordinate information and bond relations between the plurality of atoms; a string search unit configured to search for the produced one-dimensional string corresponding to the target compound in a database which was pre-established thus obtaining information about the target compound; and a search output unit configured to output the information about the target compound to the user, wherein the string conversion unit comprises an input unit configured to receive an input file in which three-dimensional coordinate information of each of a plurality of atoms of a target compound which will be expressed as a one-dimensional string is recorded in a preset format, an atom analysis unit configured to analyze bond relations between the plurality of atoms based on the three-dimensional coordinate information, in which bond relations corresponding to isomers are defined separately, an atom alignment unit configured to sequentially align the plurality of atoms based on priority of the bond relations which are preset, thus producing an array of atoms, and a string production unit configured to produce a one-dimensional string corresponding to the target compound by means of a plurality of layers which are predefined so as to express bond relations between the plurality of atoms and the array of atoms.

In addition, the present invention provides a method of searching for a compound using the apparatus for expressing a line notation for distinguishing isomers of the invention, comprising receiving from a user three-dimensional coordinate information of each of a plurality of atoms of a target compound which will be searched for; producing a one-dimensional string corresponding to the target compound based on the three-dimensional coordinate information and bond relations between the plurality of atoms; searching for the produced one-dimensional string corresponding to the target compound in a database which was pre-established, thus obtaining information about the target compound; and outputting the information about the target compound to the user, wherein the producing the string comprises receiving an input file in which three-dimensional coordinate information of each of a plurality of atoms of a target compound which will be expressed as a one-dimensional string is recorded in a preset format, analyzing bond relations between the plurality of atoms based on the three-dimensional coordinate information, in which bond relations corresponding to isomers are defined separately, sequentially aligning the plurality of atoms based on priority of the bond relations which are preset, thus producing an array of atoms, and producing a one-dimensional string corresponding to the target compound by means of a plurality of layers which are predefined so as to express bond relations between the plurality of atoms and the array of atoms.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating an apparatus for expressing a line notation for distinguishing isomers according to a preferred embodiment of the present invention;

FIG. 2 illustrates an input file in which information about a target compound is stored;

FIG. 3 illustrates symbols used when bond relations differently defined depending on the dihedral angles are represented within a one-dimensional string;

FIG. 4 illustrates the use of a modified /p layer to maintain proton information;

FIG. 5 illustrates the use of an added /en layer and a modified /t layer to show a pseudo isomer;

FIG. 6 illustrates the use of an added /nr layer in relation to a tautomer of N-methylacetamide;

FIG. 7 illustrates one-dimensional strings of compounds including metal elements;

FIG. 8 illustrates nine hybridization forms of a compound including metal element;

FIG. 9 illustrates the use of an added /fh layer to show excess hydrogen;

FIG. 10 is a flowchart illustrating a process of expressing a line notation for distinguishing isomers according to a preferred embodiment of the present invention;

FIG. 11 is a block diagram illustrating an apparatus for searching for a compound using the apparatus for expressing a line notation for distinguishing isomers according to a preferred embodiment of the present invention;

FIG. 12 is a flowchart illustrating a process of searching for a compound using the apparatus for expressing a line notation for distinguishing isomers according to a preferred embodiment of the present invention;

FIG. 13 illustrates the duplication check results between InChI and the process of the invention;

FIG. 14 illustrates the case when the numbers of hybridization forms and of hydrogens are incorrectly shown in InChI (OB);

FIG. 15 illustrates the number of different cases in the process of the invention and InChI; and

FIG. 16 illustrates a venn diagram of the duplication check results of the process of the invention and InChI.

### DESCRIPTION OF SPECIFIC EMBODIMENTS

Hereinafter, a detailed description will be given of an apparatus and method for expressing a line notation for distinguishing isomers and an apparatus and method for searching for a compound using the same according to preferred embodiments of the present invention with reference to the appended drawings.

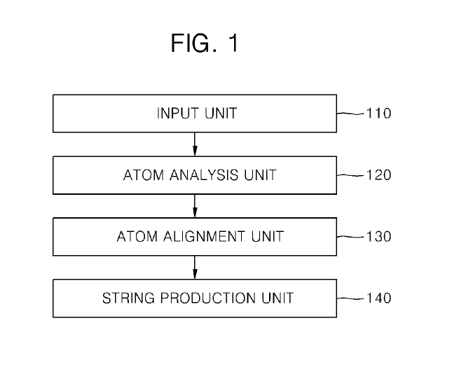

FIG. 1 is a block diagram illustrating an apparatus for expressing a line notation for distinguishing isomers according to a preferred embodiment of the present invention.

As illustrated in FIG. 1, the apparatus for expressing a line notation for distinguishing isomers according to the present invention includes an input unit 110, an atom analysis unit 120, an atom alignment unit 130 and a string production unit 140.

The input unit 110 receives an input file to which the three-dimensional coordinate information of each of a plurality of atoms which constitute a target compound which will be expressed as a one-dimensional string is recorded in a preset format. The input file adopts the standard SDF (Structure-Data File) format used in InChI.

The atom analysis unit 120 analyzes the bond relations of the plurality of atoms based on the three-dimensional coordinate information recorded in the input file, in which the bond relations corresponding to isomers are separately defined.

The atom alignment unit 130 makes the array of atoms by sequentially aligning the plurality of atoms based on priorities of the preset bond relations. Finally, the string production unit 140 produces the one-dimensional string corresponding to the target compound by means of a plurality of layers which are predefined so as to express the bond relations between the plurality of atoms and the array of atoms.

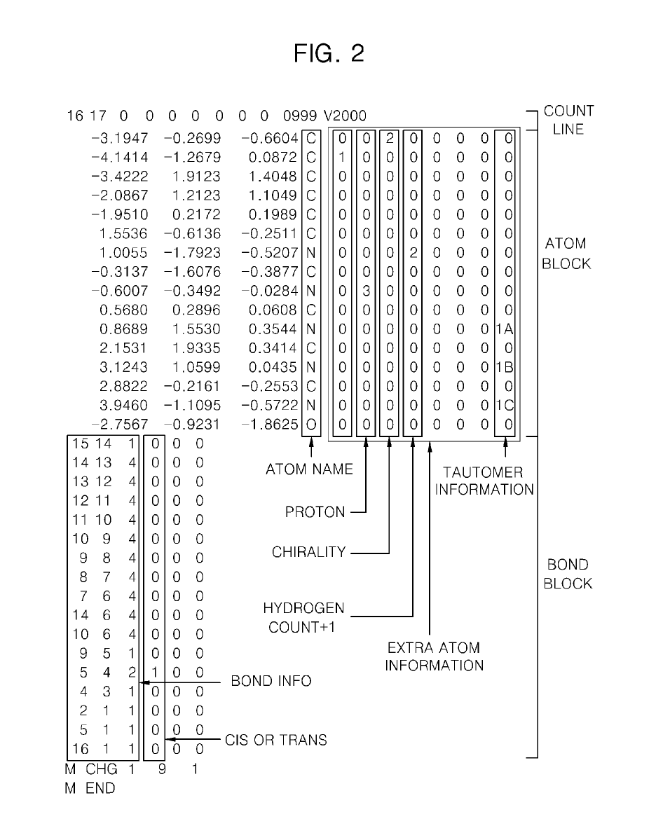

FIG. 2 illustrates the input file in which the information related to the target compound is stored.

As illustrated in FIG. 2, the input file includes a count line, an atom block, and a bond block. The atom block includes the atom name and extra atom information, as well as the three-dimensional coordinate information of each of the plurality of atoms of the target compound.

Furthermore, the extra atom information includes proton, chirality, hydrogen count+1, and tautomer information. Also, the bond block includes bond information and cis or trans information.

Specifically, the three-dimensional coordinate information of each of the plurality of atoms of the target compound is recorded in the sequence of X, Y and Z coordinates from the first column of the atom block. Because some stereochemical outputs are measured based on the coordinate axes, accuracy of analysis of the compound structure may increase in consideration of the three-dimensional coordinate information.

The input file further includes the display of mobile hydrogen which determines a tautomer among the plurality of atoms. The recorded mobile hydrogen includes the display of priorities which are imparted depending on the stability of tautomers produced by mobile hydrogen.

Concretely, the mobile hydrogen detected using a tautomer detection program is recorded in the eighth column (tautomer information) of the extra atom information.

The mobile hydrogen may be obtained from a variety of detection algorithms. Although InChI calculates the mobile hydrogen using a unique tautomer detection algorithm based on BNS (Balanced Network Searches), the accuracy thereof is still problematic.

Thus in the present invention, the tautomer information, which was previously recorded in the input file, is used in place of the tautomer detection algorithm. That is, the atoms having the same mobile hydrogen group have the same numeral in the tautomer information column.

For example, 1A, 1B and 1C are recorded in the tautomer information column of FIG. 2. In this case, the numerals designate the tautomer groups including the atoms having the same mobile hydrogen group, and the letters show the order of stability of tautomers.

The string production unit 140 allows an atom to which mobile hydrogen is bound to be displayed within the one-dimensional string depending on the mobile hydrogen recorded in the input file.

Also the input file includes proton information which displays the charge distribution of the target compound. The proton information is recorded in the third column (proton) of the extra atom information in the atom block. In this case, the string production unit 140 allows an atom to which a proton is added to be displayed within the one-dimensional string based on the proton information.

The input file includes information about an atom to which excess hydrogen is bound among the atoms of the target compound. The information about the atom to which excess hydrogen is bound is recorded in the fourth column (hydrogen count+1) of the extra atom information in the atom block. In this case, the string production unit 140 allows the atom to which excess hydrogen is bound to be displayed within the one-dimensional string.

With regard to the bond relations between the atoms of the target compound, the kinds of bond relations are recorded in the input file, particularly in the bond information column and the cis or trans information column in the bond block. In this case, the string production unit 140 allows the kinds of bond relations recorded in the input file to be displayed within the one-dimensional string.

Typically, stereochemistry of allene- or cumulene-like specific double bonds and non-rotatable single bonds is represented by cis or trans conformation. This is based on the assumption that all of atoms associated with stereochemistry are present in a planar state.

However, the dihedral angles of the compound are much closer to −90° or +90° than to 0° or 180°. If any compound has the dihedral angles of 89° and 91°, it may be determined to be cis or trans conformation based on typical cis-trans definitions.

Thus, the atom analysis unit 120 defines bond relations into four kinds for different dihedral angles, and the string production unit 140 allows the bond relations which are differently defined depending on the dihedral angles to be displayed using different symbols within the one-dimensional string.

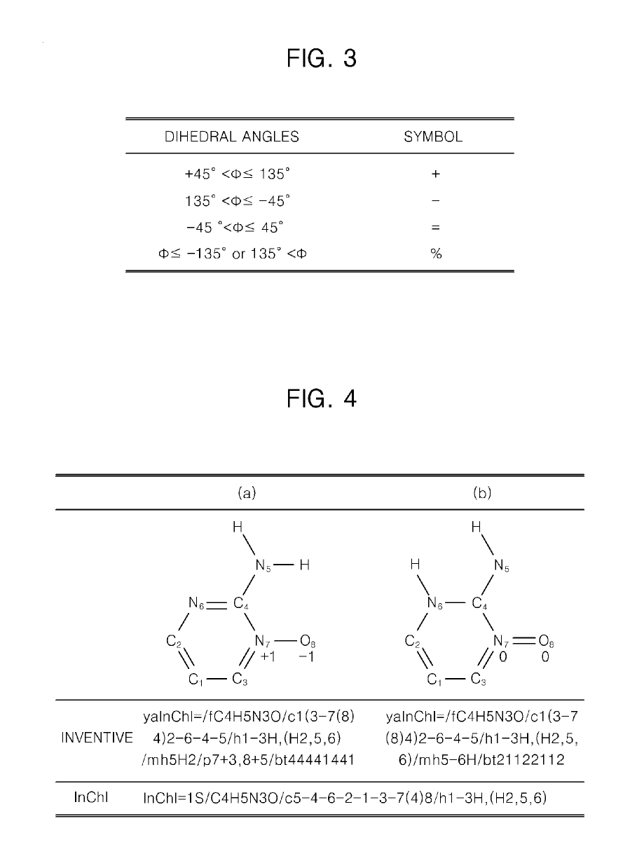

FIG. 3 illustrates the symbols used to depict the bond relations differently defined depending on the dihedral angles, which are displayed within the one-dimensional string.

As illustrated in FIG. 3, in the string production unit 140, the case where the dihedral angles are more than +45° and are not more than +135° is represented by +, and the case where it is more than −135° and is not more than −45° is represented by −, and the case when it is more than −45° and is not more than +45° is represented by =. In addition, the case where it is not more than −135° or is more than +135° is represented by %.

Conventional InChI produces a one-dimensional string corresponding to the target compound by means of a plurality of layers which are predefined so as to express the bond relations between the plurality of atoms and the array of atoms.

Among the plurality of layers, the /c layer uses connection table values based on unique atom numbers and a canonicalization process.

The connection table displays atoms in the row and the column in the matrix. The case when the bond between two atoms is formed has a matrix value of 1, and the case when the bond between two atoms is not formed has a matrix value of 0. Thus, the diagonal value of the matrix corresponds to the atom itself and thus is unconditionally 0 and the connection table is provided in the form of a symmetric matrix.

Because the atoms have to produce the same one-dimensional string for a single compound even when they are input in a different sequence into the input file, a canonicalization algorithm is used.

The canonicalization algorithm used in InChI produces the assembly of unique atom labels. In the present invention, because the string production unit 140 uses the modified or newly added layer compared to InChI, a modified canonicalization algorithm is required.

InChI selects the atom having the minimum number of branches and the minimum canonical number as a starting atom, and the remaining atoms are sequentially arranged from the atom having the minimum canonical number using the connection table values.

However, the string production unit 140 allows the array of atoms having the longest length and the minimum number of branches in the target compound to be determined as the main chain so that the order of the array of the plurality of atoms is displayed within the one-dimensional string.

On the other hand, the string production unit 140 may use the Floyd-Warshall path algorithm which finds out the shortest length for all pairs of arrays of atoms. Among paths between atoms calculated using the Floyd-Warshall path algorithm, the path having the longest length is used as the main chain.

If a plurality of paths having the longest length is present, the path the endmost atom of which has the minimum number of branches is selected as the main chain. Furthermore, the molecular length may be approximately estimated from the main chain.

Then, the string production unit 140 adds a string in front of the main chain using a method similar to that based on the connection table values as mentioned above. The newly produced string is added to the previously produced string using parentheses. This procedure is repeated until all of the pieces of information of the connection table values are used. Furthermore, the rings are expressed by using the same numeral two times.

Consequently, the length of the molecule, the number and size of the rings, the number of branches and the whole shape of the molecule may be visualized through the modified /c layer.

On the other hand, InChI adds electrons to radicals, or separates salts and metals from each other to thereby change the charge state or bond mode of the compound. Also in a new state at a normalization step, formal charges may be calculated again and thus changed. This procedure limits the original charge distribution information.

Thus, in order to maintain the charge distribution information of the compound, when the string production unit 140 produces the one-dimensional string, it uses the modified /q layer which takes into consideration the net charge information of the compound and also uses the modified /p layer which takes into consideration all pieces of information about the protonated atoms.

As mentioned above, the input file includes proton information which shows the charge distribution of the target compound. In this case, the string production unit 140 allows the atom having a proton added thereto to be displayed within the one-dimensional string using the modified /p layer based on the proton information.

FIG. 4 illustrates the use of the modified /p layer in order to maintain the proton information.

As illustrated in FIG. 4, according to InChI, the molecules (a) and (b) exhibit the same string. However, the string production unit 140 exhibits different strings using the information stored in the input file and the modified /p layer.

Also, information about the modified /p layer may have an influence on the added /mh layer and /bt layer which will be described later. Therefore, if the modified /p layer and the added /mh layer and /bt layer are removed from the string formed by the string production unit 140 in the molecule (a), the same output as in the string obtained using InChI may be attained.

Meanwhile, the net charge values of the molecules (a) and (b) of FIG. 4 are 0, and so, the modified /q layer is not expressed in the string.

InChI determines whether the number of double bonds is even or odd to decide the stereochemistry of cumulene. Concretely, in the case where the number of double bonds is even in the /t layer which will be described later, the compound shows a tetrahedral structure. Also in the case where the number of double bonds is odd in the conventional /b layer, the compound shows a cis-trans conformation.

In some cases, cumulene may have a cis-trans conformation even when the number of double bonds is even, or may have a tetrahedral conformation even when the number of double bonds is odd. This is considered to be due to the spatial constraints of the overall compound. However, InChI cannot accurately distinguish between such cases.

In order to overcome imprecision related to cumulene, the string production unit 140 uses the /en layer. When consecutive double bonds are present in the target compound, atoms positioned at both ends of the consecutive double bonds are represented by the symbols used for the bond relations adapted to the dihedral angles of FIG. 3.

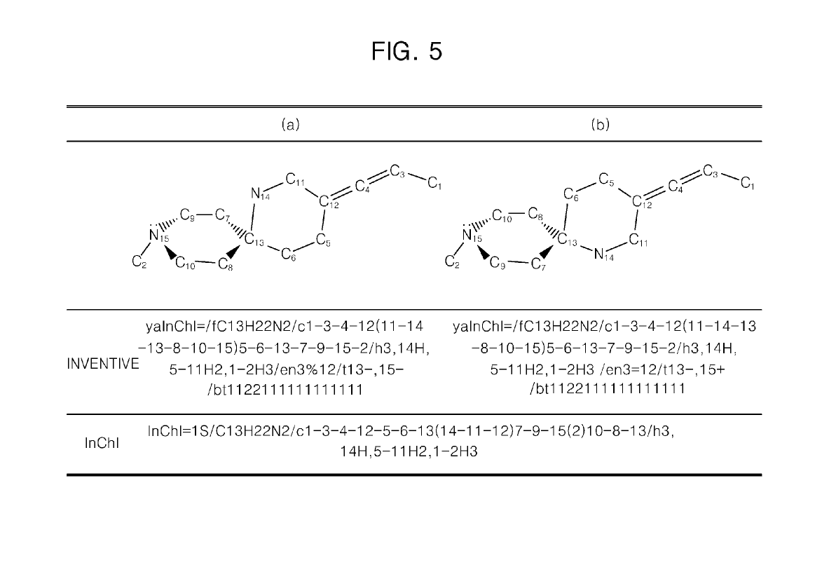

FIG. 5 illustrates the use of the added /en layer and the modified /t layer to show a pseudo isomer.

As illustrated in FIG. 5, the molecules (a) and (b) of FIG. 5 have the array of atoms of C₁-C₃-C₁₂-C₁₁ that have consecutive double bonds. In this case, the dihedral angles of C₁-C₃-C₁₂-C₁₁ may be expressed using the definitions of dihedral angles of FIG. 3 as mentioned above.

The added /en layer of the molecule (a) is represented by /en3%12, and the added /en layer of the molecule (b) is represented by /en3=12. Conclusively, the added /en layer is represented by the numerals which show the carbon atoms positioned at both ends of the array having consecutive double bonds and by the symbols for dihedral angles present between the numerals.

The concept of parity is similar to chirality. Chirality refers to morphological features in which an image cannot be superimposed on its mirror image, that is, a pair of enantiomers is present.

The parity may provide spatial orientation information about the four branches attached to the central atom. Also parity uses canonical numbers of atoms in lieu of weight or branch priority.

According to InChI, the case when there are four different branches or where central atoms have an even number of double bonds may have parity, which is represented by the /t layer. However, the string production unit 140 allows the atom having four branches bound thereto and the atom having three branches and a lone pair bound thereto such as an sp³ orbital to be displayed in the same layer of the one-dimensional string. This is because the position of the lone pair cannot change freely.

For example, the string production unit 140 allows atoms such as N₁₅ of the molecules (a) and (b) of FIG. 5 to be displayed in the same layer because parity is regarded as being present even when there are three different branches as well as a lone pair.

C₁₃ of the molecules (a) and (b) has only three different branches. However, the molecules (a) and (b) cannot be distinguished if C₁₃ does not show parity according to InChI.

Also in the molecule (a), the lone pair of N₁₅ is closer to N₁₄, and in the molecule (b) the lone pair of N₁₅ is closer to C₆, but they are expressed as the same string according to InChI.

However, the string production unit 140 may express the molecules (a) and (b) as different strings by using the added /en layer and the modified /t layer. Also the symbol ‘+’ which follows the atomic number indicates the clockwise direction, and the symbol ‘−’ indicates the counterclockwise direction, and the spatial array of atoms is shown in proportion to the canonical number. In this case, the lone pair has the lowest priority.

A peptide bond such as the C—N bond of protein is a non-rotatable single bond and thus cannot rotate freely. Because of sp²-sp² hybridization present because of the characteristics of a double bond, the molecules have different stereochemistries around the C—N bond. However, InChI does not take into consideration non-rotatable single bonds.

The string production unit 140 allows the atoms connected by the non-rotatable single bonds in the target compound to be displayed within the one-dimensional string using the /nr layer.

The non-rotatable single bonds include sp² carbons connected to three nitrogen atoms like the amide group and hydroxyl arginine.

Because the non-rotatable single bonds may have an angle close to 90° and −90°, the added /nr layer uses the definition of symbols for the dihedral angles of the double bonds of FIG. 3. The non-rotatable single bonds may be present in various forms within the same molecule.

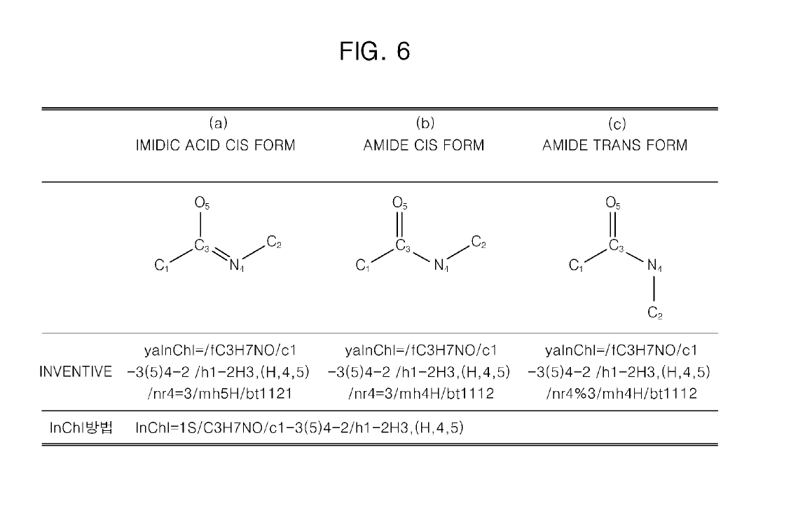

FIG. 6 illustrates the use of the added /nr layer with regard to the tautomer of N-methylacetamide.

As illustrated in FIG. 6, the compound (a) is cis imidic acid, the compound (b) is cis amide, and the compound (c) is trans amide.

The amide may be converted into imidic acid via tautomerization. Thus, the added /nr layer shows the same string in the compounds (a) and (b). According to InChI, these two cases exhibit a cis conformation. However, in the case of the compound (c), stereochemistry around the non-rotatable bond cannot be confirmed.

The string production unit 140 produces the one-dimensional string using the numerals which indicate atoms at both ends of the non-rotatable single bond in the added /nr layer and using the symbols of dihedral angels present between the numerals.

According to InChI, all metal atoms of an organic metal compound are not connected in the main layer (conventional /f layer, /c layer and /h layer), and are not regarded as the moiety of a molecule.

The string production unit 140 allows the metal atom contained in the target compound and the atoms bound around the metal atom to be displayed within the one-dimensional string using the /mt layer.

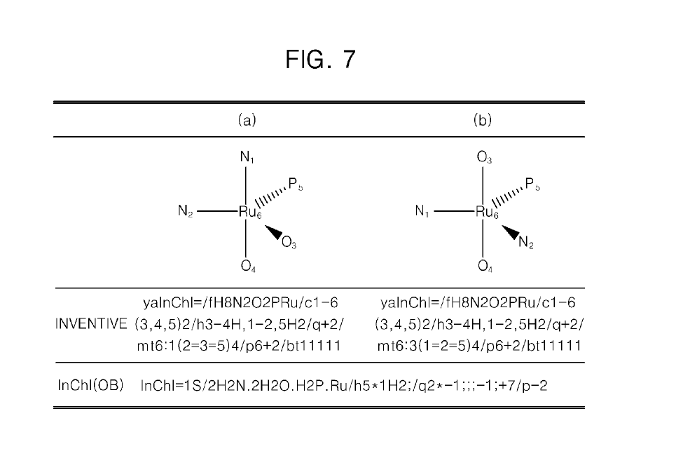

FIG. 7 illustrates the one-dimensional strings of compounds including metal elements.

As illustrated in FIG. 7, the metal atoms in the molecule may have a variety of hybridization forms and geometrical shapes.

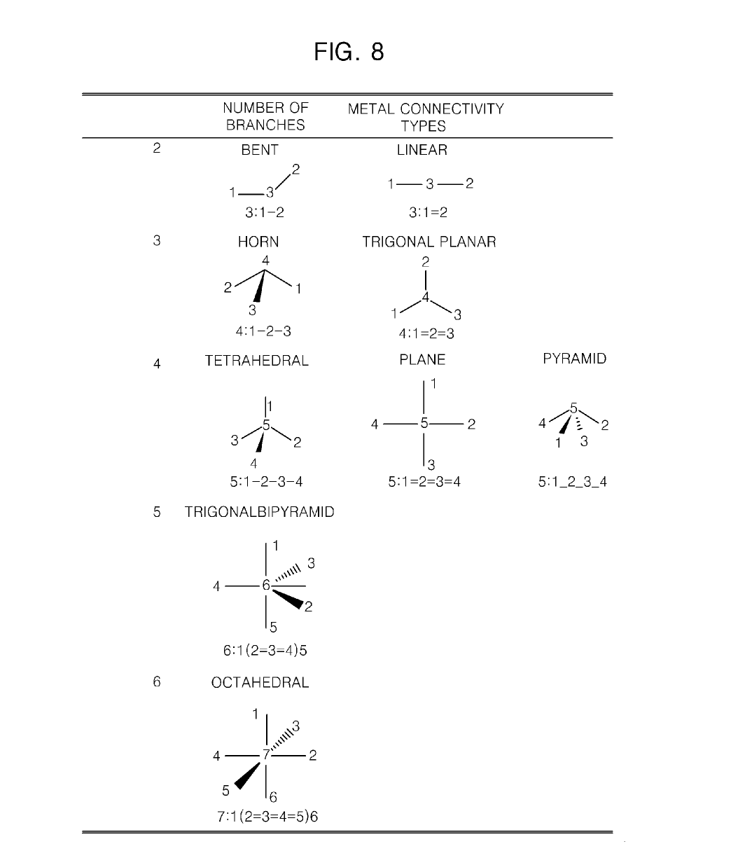

FIG. 8 illustrates nine hybridization forms of the compound including metal element.

As illustrated in FIG. 8, the compound including metal element may be provided in a total of nine hybridization forms, and may have a maximum of six bonds. Meanwhile, the stereochemistry of a distorted molecule may be estimated using three-dimensional coordinate information stored in the input file and is selected from among the nine hybridization forms.

In the added /mt layer, the first numeral indicates the canonical number of a metal central atom, and the numeral after the symbol ‘:’ shows the atom attached to the central atom. When two or three branches are provided, another symbol may be inserted between the numerals. For example, the inserted symbols ‘−’, ‘=’ and ‘_’ show different shapes.

When there are two, three and four branches, the first numeral after ‘:’ indicates the smallest number among atoms attached all the time and the second numeral indicates the next atom in the clockwise direction.

When there are five and six branches, the numeral in parentheses shows the atom in a plane from the smallest number in the clockwise direction. The numeral before the symbol “(” designates an axial atom having the smaller canonical number. The numeral after the symbol “)” designates an axial atom having the larger canonical number. The atoms on the plane and in axial directions are estimated from the coordinates of atoms given in the input file.

Meanwhile, the string production unit 140 produces the one-dimensional string corresponding to the target compound using the /mh layer and the /fh layer related to the extra hydrogen of the tautomer.

According to InChI, a pair of atoms is provided between parentheses and shows the mobile hydrogen group for the tautomer in the /h layer. For example, (H2, 5, 6) indicates that two hydrogen atoms are connected to N₅ or N₆ atom, and the position of such hydrogen atoms may change. Also, according to InChI, mobile hydrogen is calculated using the tautomer detection algorithm based on unique BNS.

As mentioned above, however, there are criticisms made about the accuracy of the tautomer detection algorithm. Thus, the display of mobile hydrogen which determines the tautomer among a plurality of atoms is further recorded in the input file.

The recorded mobile hydrogen includes the display of the priority which is imparted depending on the stability of tautomers produced by mobile hydrogen. Depending on the mobile hydrogen recorded in the input file, the string production unit 140 allows the atom to which mobile hydrogen is bound to be displayed within the one-dimensional string using the /mh layer.

Meanwhile, the input file includes information about an atom to which excess hydrogen is bound among atoms contained in the target compound. In this case, the string production unit 140 allows the atom to which excess hydrogen is bound to be displayed within the one-dimensional string using the /fh layer.

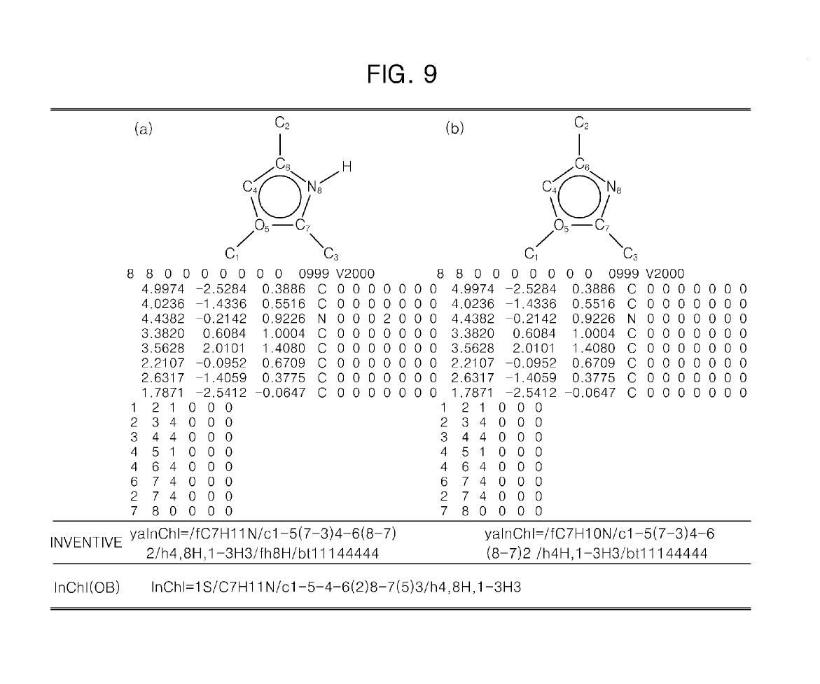

FIG. 9 illustrates the use of the added /fh layer to show excess hydrogen.

As illustrated in FIG. 9, the N₈ atom of the molecule (a) has the value 2 in the hydrogen count+1 column of the input file. This means that the molecule (a) has an excess hydrogen. In contrast, the molecule (b) has no excess hydrogen.

Thus, according to InChI, the molecules (a) and (b) have the same string, but the string production unit 140 allows the molecules (a) and (b) to be displayed in the different strings using the added /fh layer.

According to InChI, a variety of bonds of compounds are not clearly shown. The case when the compound is a tautomer or has various protonation states makes it difficult to express the bond mode using the predefined layer.

The bond mode may be calculated using given information such as the kind of atom, the number of attached hydrogen atoms and the charge state. However, in the case of the compound having a complicated structure, the designated bond mode is unclear and it is difficult to calculate aromaticity from the non-aromatic bond mode.

As mentioned above, the input file includes kinds of bond relations of atoms contained in the target compound. In this case, the string production unit 140 allows the kinds of bond relations recorded in the input file to be displayed within the one-dimensional string using the /bt layer.

That is, the information of original bond mode considering the specific type of tautomer and charge state thereof may be retained using the added /bt layer. The bond information for producing the /bt layer is classified in descending order using lexicographical comparison.

The first and second atoms are classified by the atomic number in descending order. Then, each of pairs of atoms is classified in lexicographical comparison in descending order.

Specifically, 1 designates a single bond, 2 designates a double bond, 3 designates a triple bond, 4 designates aromatic, 5 designates a single bond or double bond, 6 designates a single bond or aromatic, 7 designates a double bond or aromatic and 8 designates the others.

The intramolecular bond is confined, and thus in the case when the bond order is set using a specific rule, even when atoms are not displayed but only the kinds of bonds are shown, desired information may be obtained.

For example, the atoms may be displayed according to a rule such as (1, 2)<(2, 3) or (3, 4)<(3, 5). The numerals in the bond modes are in the range of 1˜8, and agree with the definitions in the input file (SDF).

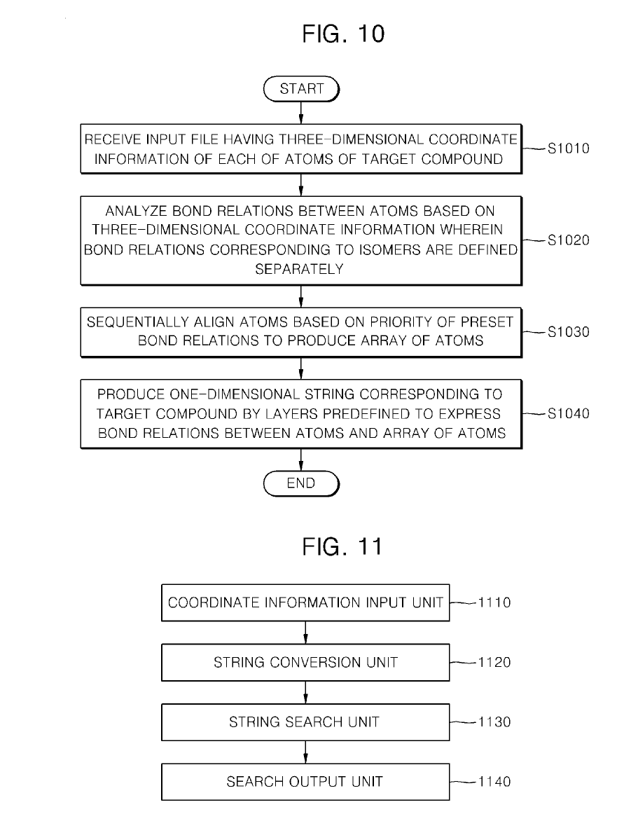

FIG. 10 illustrates a process of expressing the line notation for distinguishing isomers according to a preferred embodiment of the present invention.

The input unit 110 receives an input file in which three-dimensional coordinate information of each of a plurality of atoms of a target compound which will be expressed as a one-dimensional string is recorded in a preset format at step S1010.

The atom analysis unit 120 analyzes the bond relations between the plurality of atoms based on the three-dimensional coordinate information in which the bond relations corresponding to isomers are separately defined at step S1020.

The atom alignment unit 130 sequentially aligns the plurality of atoms based on the priority of the bond relations which are preset, thus producing the array of atoms at step S1030.

Finally, the string production unit 140 produces the one-dimensional string corresponding to the target compound by means of a plurality of layers which are predefined so as to express the bond relations between the plurality of atoms and the array of atoms at step S1040.

In the present invention, the /en, /nr, /mt, /mh, /fh and /bt layers were added to the layers according to InChI. Also, the /c, /q, /p and /t layers were modified. Also, /m and /s layers were deleted and the others remained the same.

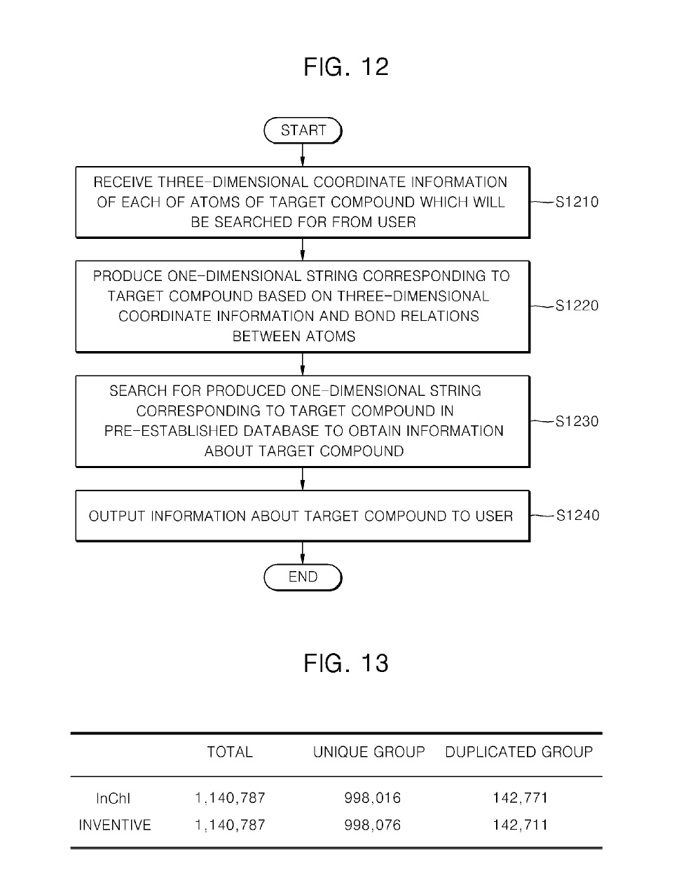

FIG. 11 is a block diagram illustrating an apparatus for searching for a compound using the apparatus for expressing a line notation for distinguishing isomers according to a preferred embodiment of the present invention, and FIG. 12 is a flowchart illustrating a process of searching for the compound using the apparatus for expressing the line notation for distinguishing isomers according to a preferred embodiment of the present invention.

A coordinate information input unit 1110 receives, from a user, the three-dimensional coordinate information of each of the plurality of atoms of a target compound which will be searched for at step S1210.

A string conversion unit 1120 produces a one-dimensional string corresponding to the target compound based on the three-dimensional coordinate information and the bond relations between the plurality of atoms at step S1220. The string conversion unit 1120 has the same configuration as does the apparatus for expressing the line notation for distinguishing isomers as mentioned above.

Concretely, the string conversion unit 1120 includes the input unit 110, the atom analysis unit 120, the atom alignment unit 130 and the string production unit 140 as illustrated in FIG. 1.

A string searching unit 1130 searches for the produced one-dimensional string corresponding to the target compound in a database which was pre-established to obtain information about the target compound at step S1230. Stored in the database are one-dimensional strings produced using an apparatus which is the same as the string conversion unit 1120.

A search output unit 1140 outputs the information about the target compound to the user at step S1240.

In order to evaluate the performance of the present invention, the following test was conducted. Among molecules stored in Ligand. Info Meta Database (ver. 1.02), molecules in which three-dimensional coordinate information was deficient or were present in duplicate were removed, and molecules for measuring the test results were added, and thus a total of 1,140,787 molecules were used.

FIG. 13 illustrates the duplication check results between the method of the invention and InChI.

In a large-capacity compound database, there are many cases in which the same compound is stored under different serial numbers. Thus, the duplicated compounds are filtered using a duplication check thus efficiently controlling the database.

As illustrated in FIG. 13, the number of unique molecules calculated in the invention is larger than when using InChI because of improved stereochemical expression.

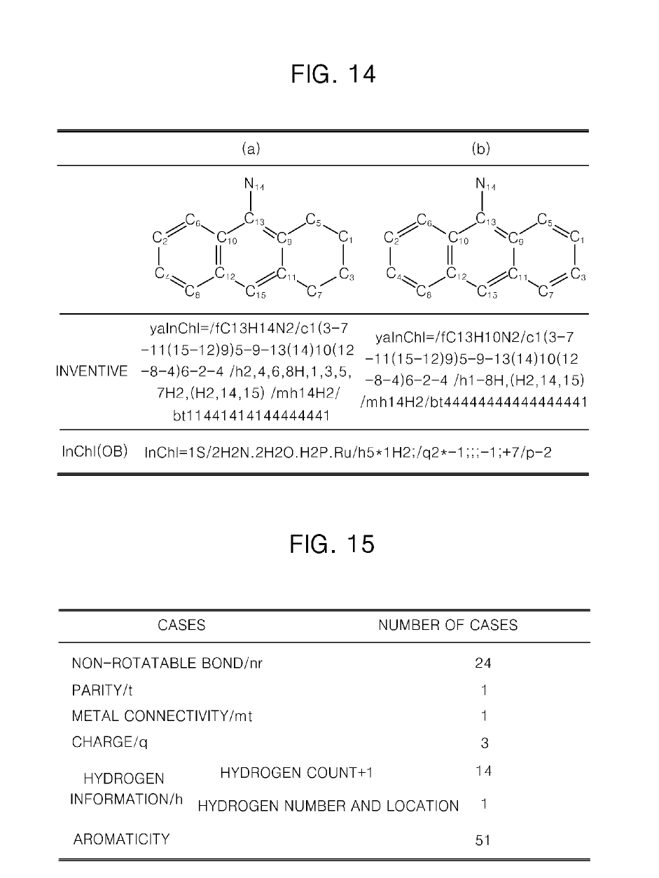

FIG. 14 illustrates the case where the numbers of hybridization forms and hydrogens are incorrectly shown in InChI (OB).

As illustrated in FIG. 14, according to InChI, two different molecules are handled as the same one. However, the molecule (a) has sp³ carbon, and the molecule (b) has no sp³ carbon. Also, the molecule (a) has 14 hydrogen atoms, and the molecule (b) has 10 hydrogen atoms.

FIG. 15 illustrates the number of different cases in the method of the invention and InChI.

As illustrated in FIG. 15, the added /nr layer shows 24 types, the modified /t layer shows one type, the added /mt layer shows one type, the modified /q layer shows three types, the /h layer shows 15 types, and the aromaticity shows 51 types.

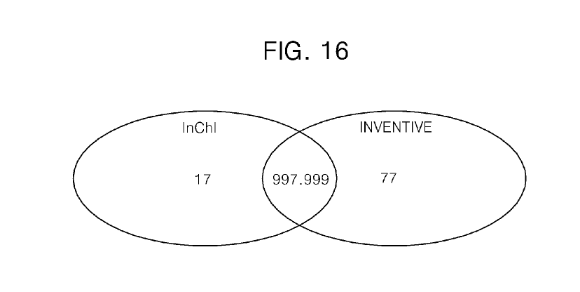

FIG. 16 illustrates the venn diagram of duplication check results in the method of the invention and InChI.

As illustrated in FIG. 16, the number of cases corresponding to both of InChI and the method of the invention is 997,999. The number of cases corresponding only to InChI is 17, and the number of cases corresponding only to the method of the invention is 77.

Table 1 below shows the layers in the method of the invention and InChI.

TABLE 1

| Layer | | Meaning of Layer | Difference |
|---|---|---|---|
| Main Layer | /f | chemical formula | no change |
| | /c | connectivity | modified |
| | | | (specific/c layer) |
| | /h | hydrogen (mobile hydrogen) | non-modified, obtaining information |
| | | | from input file |
| Charge Layer | /q | net charge | modified |
| | | | (net charge of molecule) |
| | /p | protonation | modified |
| | | | (information of all protonated atoms) |
| Stereo Layer | /b | cis-trans double bond | No change |
| | /en | allene or cumulene | added |
| | | | (structural information of series of |
| | | | double bond) |
| | /t | parity | modified |
| | | | (includes atoms having 3 different |
| | | | branches with a lone pair and 4 |
| | | | branches having 3 or 4 different |
| | | | branches) |
| | /nr | non-rotatable bond | added (structural information of non- |
| | | | rotatable single bond) |
| | /mt | metal connectivity | added (structural information of metal |
| | | | connectivity) |
| | /m | parity inverted to obtain | deleted |
| | | relative stereo | |
| | /s | stereo type | deleted |
| Extra Layer | /i | isotope | no change |
| | /mh | tautomer-specific hydrogen | added |
| | | | (original tautomer specific hydrogen |
| | | | information) |
| | /fh | hydrogen count + 1 | added |
| | | | (original value of hydrogen count + 1 |
| | | | column) |
| | /bt | bond table | added |
| | | | (bond information of given input) |

The present invention may be implemented in the form of computer-readable code that is stored in a computer-readable storage medium. The computer-readable storage medium includes all types of storage devices in which computer system-readable data may be stored. Examples of the computer-readable storage medium are ROM (Read Only Memory), RAM (Random Access Memory), CD-ROM (Compact Disk-Read Only Memory), magnetic tape, a floppy disk, an optical data storage device, etc. Furthermore, the computer-readable storage medium may be implemented in the form of carrier waves (e.g. in the case of transmission via the Internet). Moreover, the computer-readable storage medium may be distributed across computer systems connected via a network, and may be configured such that computer-readable code is stored and executed in a distributed manner.

As described hereinbefore, the present invention provides an apparatus and method for expressing a line notation for distinguishing isomers and an apparatus and method for searching for a compound using the same. According to the present invention, stereoisomers of compounds having peptide bonds, compounds having consecutive double bonds or metal compounds can be more clearly distinguished. With regard to the double bonds of the compound, four kinds of notation can be used in lieu of the dual notation of cis and trans conformations, and the structural properties of the compound can be more specifically applied. Whether the compounds are duplicated can be accurately checked in a large-capacity database. Also, because the one-dimensional string includes more information about the three-dimensional structure of the compound, the three-dimensional structure of the compound can be distinctly deduced from the one-dimensional string.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for expressing a line notation, comprising:
an input unit configured to receive an input file in which three-dimensional coordinate information of each of a plurality of atoms of a target compound which will be expressed as a one-dimensional string is recorded in a preset format;
an atom analysis unit configured to analyze bond relations between the plurality of atoms based on the three-dimensional coordinate information, in which bond relations corresponding to isomers are defined separately;
an atom alignment unit configured to sequentially align the plurality of atoms based on priority of the bond relations which are preset, thus producing an array of atoms; and
a string production unit configured to produce a one-dimensional string corresponding to the target compound by means of a plurality of layers which are predefined so as to express bond relations between the plurality of atoms and the array of atoms.

2. The apparatus of claim 1, wherein the input file further comprises displaying mobile hydrogen which determines a tautomer among the plurality of atoms, and the string production unit allows an atom to which the mobile hydrogen is bound to be displayed within the one-dimensional string.

3. The apparatus of any one of claim 1, wherein the atom analysis unit defines the bond relations into four kinds for different dihedral angles, and the string production unit allows the bond relations which are differently defined depending on the dihedral angles to be displayed as different symbols within the one-dimensional string.

4. The apparatus of claim 3, wherein when consecutive double bonds are included in the target compound, the string production unit allows atoms positioned at both ends of the consecutive double bonds to be displayed as symbols used to depict the bond relations depending on the dihedral angles.

5. The apparatus of any one of claim 1, wherein the string production unit allows atoms connected by a non-rotatable single bond in the target compound to be displayed within the one-dimensional string.

6. The apparatus of any one of claim 1, wherein the string production unit allows a metal atom contained in the target compound and atoms bound around the metal atom to be displayed within the one-dimensional string.

7. The apparatus of any one of claim 1, wherein the input file includes information about an atom having excess hydrogen bound thereto among atoms of the target compound, and the string production unit allows the atom having excess hydrogen bound thereto to be displayed within the one-dimensional string.

8. The apparatus of any one of claim 1, wherein the input file includes kinds of bond relations between the atoms of the target compound, and the string production unit allows the kinds of bond relations recorded in the input file to be displayed within the one-dimensional string.

9. A method of expressing a line notation, comprising:
receiving an input file in which three-dimensional coordinate information of each of a plurality of atoms of a target compound which will be expressed as a one-dimensional string is recorded in a preset format;
analyzing bond relations between the plurality of atoms based on the three-dimensional coordinate information, in which bond relations corresponding to isomers are defined separately;
sequentially aligning the plurality of atoms based on priority of the bond relations which are preset, thus producing an array of atoms; and
producing a one-dimensional string corresponding to the target compound by means of a plurality of layers which are predefined so as to express bond relations between the plurality of atoms and the array of atoms.

10. The method of claim 9, wherein the input file further comprises displaying mobile hydrogen which determines a tautomer among the plurality of atoms, and the producing the string comprises allowing an atom to which the mobile hydrogen is bound to be displayed within the one-dimensional string.

11. The method of any one of claim 9, wherein the analyzing the bond relations comprises defining bond relations into four kinds for different dihedral angles, and the producing the string comprises allowing the bond relations which are differently defined depending on the dihedral angles to be displayed as different symbols within the one-dimensional string.

12. The method of claim 11, wherein, when consecutive double bonds are included in the target compound, the producing the string comprises allowing atoms positioned at both ends of the consecutive double bonds to be displayed as symbols used to depict the bond relations depending on the dihedral angles.

13. The method of any one of claim 9, wherein the producing the string comprises allowing atoms connected by a non-rotatable single bond in the target compound to be displayed within the one-dimensional string.

14. The method of any one of claim 9, wherein the producing the string comprises allowing a metal atom contained in the target compound and atoms bound around the metal atom to be displayed within the one-dimensional string.

15. The method of any one of claim 9, wherein the input file includes information about an atom having excess hydrogen bound thereto among atoms of the target compound, and the producing the string comprises allowing the atom having excess hydrogen bound thereto to be displayed within the one-dimensional string.

16. The method of any one of claim 9, wherein the input file includes kinds of bond relations between atoms of the target compound, and the producing the string comprises allowing the kinds of bond relations recorded in the input file to be displayed within the one-dimensional string.

17. An apparatus for searching for a compound, comprising:
a coordinate information input unit configured to receive from a user three-dimensional coordinate information of each of a plurality of atoms of a target compound which will be searched for;
a string conversion unit configured to produce a one-dimensional string corresponding to the target compound based on the three-dimensional coordinate information and bond relations between the plurality of atoms;
a string search unit configured to search for the produced one-dimensional string corresponding to the target compound in a database which was pre-established thus obtaining information about the target compound; and
a search output unit configured to output the information about the target compound to the user,
wherein the string conversion unit comprises:
an input unit configured to receive an input file in which three-dimensional coordinate information of each of a plurality of atoms of a target compound which will be expressed as a one-dimensional string is recorded in a preset format;
an atom analysis unit configured to analyze bond relations between the plurality of atoms based on the three-dimensional coordinate information, in which bond relations corresponding to isomers are defined separately;
an atom alignment unit configured to sequentially align the plurality of atoms based on priority of the bond relations which are preset, thus producing an array of atoms; and
a string production unit configured to produce a one-dimensional string corresponding to the target compound by means of a plurality of layers which are predefined so as to express bond relations between the plurality of atoms and the array of atoms.

18. The apparatus of claim 17, wherein the database includes one-dimensional strings produced using an apparatus which is same as the string conversion unit.

19. A method of searching for a compound, comprising:
receiving from a user three-dimensional coordinate information of each of a plurality of atoms of a target compound which will be searched for;
producing a one-dimensional string corresponding to the target compound based on the three-dimensional coordinate information and bond relations between the plurality of atoms;
searching for the produced one-dimensional string corresponding to the target compound in a database which was pre-established, thus obtaining information about the target compound; and
outputting the information about the target compound to the user,
wherein the producing the string comprises:
receiving an input file in which three-dimensional coordinate information of each of a plurality of atoms of a target compound which will be expressed as a one-dimensional string is recorded in a preset format;
analyzing bond relations between the plurality of atoms based on the three-dimensional coordinate information, in which bond relations corresponding to isomers are defined separately;
sequentially aligning the plurality of atoms based on priority of the bond relations which are preset, thus producing an array of atoms; and
producing a one-dimensional string corresponding to the target compound by means of a plurality of layers which are predefined so as to express bond relations between the plurality of atoms and the array of atoms.

20. The method of claim 19, wherein the database includes one-dimensional strings produced using a process which is same as the producing the string.
